(19) United States
(12) Patent Application Publication
(10) Pub. No.: US 2017/0158564 A1
(43) Pub. Date: Jun. 8, 2017

(54) SUPER HARD CONSTRUCTIONS & METHODS OF MAKING SAME

(71) Applicant: Element Six (UK) Limited, Oxfordshire (GB)

(72) Inventor: Mehmet Serdar OZBAYRAKTAR, Oxfordshire (GB)

(21) Appl. No.: 15/324,142

(22) PCT Filed: Jul. 6, 2015
(86) PCT No.: PCT/EP2015/065318

§ 371 Date: Jan. 5, 2017

(30) Foreign Application Priority Data
Jul. 7, 2014 (GB) 1412073.7

(51) Int. Cl. C04B 35/528; E21B 10/567; B24D 18/00; C22C 26/00; C04B 35/645; C04B 37/00

(52) U.S. Cl. CPC C04B 35/528; C04B 35/645; C04B 37/001; B24D 18/0009; C22C 26/00; E21B 10/567; C04B 2235/425; C04B 2235/5454; C04B 2235/5445; C04B 2235/656; C04B 2235/781; C04B 2235/785; C04B 2235/85; C04B 2237/363; C04B 2237/36; E21B 10/50

(57) ABSTRACT

A super hard polycrystalline construction comprises a body of polycrystalline super hard material comprising a first fraction of super hard grains and a second fraction of super hard grains, the first fraction having a greater average grain size than the super hard grains in the second fraction, the super hard grains in the first and second fraction having a peripheral surface. The super hard grains in the first fraction are bonded along at least a portion of the peripheral surface to at least a portion of a plurality of super hard grains in the second fraction, the super hard grains in the first fraction being spaced from adjacent grains in the first fraction by a distance of between around 50 to around 500 nm.

### FIELD

This disclosure relates to super hard constructions and methods of making such constructions, particularly but not exclusively to constructions comprising polycrystalline diamond (PCD) structures attached to a substrate, and tools comprising the same, particularly but not exclusively for use in rock degradation or drilling, or for boring into the earth.

### BACKGROUND

Polycrystalline super hard materials, such as polycrystalline diamond (PCD) may be used in a wide variety of tools for cutting, machining, drilling or degrading hard or abrasive materials such as rock, metal, ceramics, composites and wood-containing materials. In particular, tool inserts in the form of cutting elements comprising PCD material are widely used in drill bits for boring into the earth to extract oil or gas. The working life of super hard tool inserts may be limited by fracture of the super hard material, including by spalling and chipping, or by wear of the tool insert.

Cutting elements such as those for use in rock drill bits or other cutting tools typically have a body in the form of a substrate which has an interface end/surface and a super hard material which forms a cutting layer bonded to the interface surface of the substrate by, for example, a sintering process. The substrate is generally formed of a tungsten carbide-cobalt alloy, sometimes referred to as cemented tungsten carbide and the super hard material layer is typically polycrystalline diamond (PCD), or a thermally stable product TSP material such as thermally stable polycrystalline diamond.

Polycrystalline diamond (PCD) is an example of a super hard material (also called a super abrasive material or ultra hard material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example. A material wholly or partly filling the interstices may be referred to as filler or binder material.

PCD is typically formed in the presence of a sintering aid such as cobalt, which promotes the inter-growth of diamond grains. Suitable sintering aids for PCD are also commonly referred to as a solvent-catalyst material for diamond, owing to their function of dissolving, to some extent, the diamond and catalysing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. Most typically, PCD is often formed on a cobalt-cemented tungsten carbide substrate, which provides a source of cobalt solvent-catalyst for the PCD. Materials that do not promote substantial coherent intergrowth between the diamond grains may themselves form strong bonds with diamond grains, but are not suitable solvent-catalysts for PCD sintering.

Cemented tungsten carbide, which may be used to form a suitable substrate, is formed from carbide particles being dispersed in a cobalt matrix by mixing tungsten carbide particles/grains and cobalt together then heating to solidify. To form the cutting element with a super hard material layer such as PCD, diamond particles or grains are placed adjacent the cemented tungsten carbide body in a refractory metal enclosure such as a niobium enclosure and are subjected to high pressure and high temperature so that inter-grain bonding between the diamond grains occurs, forming a polycrystalline super hard diamond layer.

In some instances, the substrate may be fully cured prior to attachment to the super hard material layer whereas in other cases, the substrate may be green, that is, not fully cured. In the latter case, the substrate may fully cure during the HTHP sintering process. The substrate may be in powder form and may solidify during the sintering process used to sinter the super hard material layer.

Ever increasing drives for improved productivity in the earth boring field place ever increasing demands on the materials used for cutting rock. Specifically, PCD materials with improved abrasion and impact resistance are required to achieve faster cut rates and longer tool life.

Cutting elements or tool inserts comprising PCD material are widely used in drill bits for boring into the earth in the oil and gas drilling industry. Rock drilling and other operations require high abrasion resistance and impact resistance. One of the factors limiting the success of the polycrystalline diamond (PCD) abrasive cutters is the generation of heat due to friction between the PCD and the work material. This heat causes the thermal degradation of the diamond layer. The thermal degradation increases the wear rate of the cutter through increased cracking and spalling of the PCD layer as well as back conversion of the diamond to graphite causing increased abrasive wear.

Methods used to improve the abrasion resistance of a PCD composite often result in a decrease in impact resistance of the composite.

The most wear resistant grades of PCD usually suffer from a catastrophic fracture of the cutter before it has worn out. During the use of these cutters, cracks grow until they reach a critical length at which catastrophic failure occurs, namely, when a large portion of the PCD breaks away in a brittle manner. These long, fast growing cracks encountered during use of conventionally sintered PCD, result in short tool life.

Furthermore, despite their high strength, polycrystalline diamond (PCD) materials are usually susceptible to impact fracture due to their low fracture toughness. Improving fracture toughness without adversely affecting the material's high strength and abrasion resistance is a challenging task.

There is therefore a need for a PCD composite that has good or improved abrasion, fracture and impact resistance and a method of forming such composites.

### SUMMARY

Viewed from a first aspect there is provided a super hard polycrystalline construction comprising:
a body of polycrystalline super hard material comprising a first fraction of super hard grains and a second fraction of super hard grains, the first fraction having a greater average grain size than the super hard grains in the second fraction;
the super hard grains in the first and second fraction having a peripheral surface; wherein
the super hard grains in the first fraction are bonded along at least a portion of the peripheral surface to at least a portion of a plurality of super hard grains in the second fraction;
the super hard grains in the first fraction being spaced from adjacent grains in the first fraction by a distance of between around 50 to around 500 nm.

Viewed from a second aspect there is provided a method of forming a super hard polycrystalline construction, comprising:
providing a first mass of particles or grains of super hard material forming a first fraction and a mass of particles or grains of super hard material forming a second fraction to form a pre-sinter assembly; the first fraction having a greater average grain size than the super hard grains in the second fraction; the first fraction comprising two or more average particle sizes; the second fraction comprising grains having an average particle size of between around 50 to around 500 nm;
treating the pre-sinter assembly in the presence of a catalyst/solvent material for the super hard grains at an ultra-high pressure of around 5 GPa or greater and a temperature to sinter together the grains of super hard material to form a body of polycrystalline super hard material, the super hard grains exhibiting inter-granular bonding and defining a plurality of interstitial regions therebetween;
the super hard grains in the first and second fraction having a peripheral surface; wherein
the super hard grains in the first fraction are bonded along at least a portion of the peripheral surface to at least a portion of a plurality of super hard grains in the second fraction;
the super hard grains in the first fraction being spaced from adjacent grains in the first fraction by a distance of between around 50 to around 500 nm.

### BRIEF DESCRIPTION OF THE DRAWINGS

The present invention will now be described by way of example and with reference to the accompanying drawings in which:

FIG. 1 is a perspective view of an example PCD cutter element or construction for a drill bit for boring into the earth;

FIG. 2 is a schematic cross-section of a portion of a conventional PCD microstructure with interstices between the inter-bonded diamond grains filled with a non-diamond phase material;

FIG. 3 is a schematic cross-section of a portion of an example PCD microstructure;

FIG. 4a is a plot showing the monomodal particle size distribution of diamond grains in the starting powder used to form a first conventional body of PCD material;

FIG. 4b is a plot showing the bimodal particle size distribution of diamond grains in the starting powder used to form a second conventional body of PCD material;

FIG. 4c is a plot showing the trimodal particle size distribution of diamond grains in the starting powder used to form a first example body of PCD material;

FIG. 4d is a plot showing the quadmodal particle size distribution of diamond grains in the starting powder used to form a second example body of PCD material;

FIG. 5 is a plot showing the vol % of binder (Co) content in the microstructure of each of the materials of FIGS. 4a to 4b, after sintering at pressures of 5.5, 6.8 and 7.7 GPa;

FIG. 6 is a plot showing the diamond contiguity by percent of area in the microstructure of each of the materials of FIGS. 4a to 4b, after sintering at pressures of 5.5, 6.8 and 7.7 GPa;

FIG. 7 is a plot showing the results of a vertical borer test comparing conventional PCD cutter elements and example cutter elements or constructions sintered at a pressure of 5.5 GPa; and

FIG. 8 is a plot showing the results of a vertical borer test comparing conventional PCD cutter elements and example cutter elements or constructions sintered at a pressure of 6.8 GPa.

The same references refer to the same general features in all the drawings.

### DESCRIPTION

As used herein, a “super hard material” is a material having a Vickers hardness of at least about 28 GPa. Diamond and cubic boron nitride (cBN) material are examples of super hard materials.

As used herein, a “super hard construction” means a construction comprising a body of polycrystalline super hard material. In such a construction, a substrate may be attached thereto or alternatively the body of polycrystalline material may be free-standing and unbacked.

As used herein, polycrystalline diamond (PCD) is a type of polycrystalline super hard (PCS) material comprising a mass of diamond grains, a substantial portion of which are directly inter-bonded with each other and in which the content of diamond is at least about 80 volume percent of the material. In one example of PCD material, interstices between the diamond grains may be at least partly filled with a binder material comprising a catalyst for diamond. As used herein, “interstices” or “interstitial regions” are regions between the diamond grains of PCD material. In examples of PCD material, interstices or interstitial regions may be substantially or partially filled with a material other than diamond, or they may be substantially empty. PCD material may comprise at least a region from which catalyst material has been removed from the interstices, leaving interstitial voids between the diamond grains.

A “catalyst material” for a super hard material is capable of promoting the growth or sintering of the super hard material.

The term “substrate” as used herein means any substrate over which the super hard material layer is formed. For example, a “substrate” as used herein may be a transition layer formed over another substrate.

As used herein, the term “integrally formed” regions or parts are produced contiguous with each other and are not separated by a different kind of material.

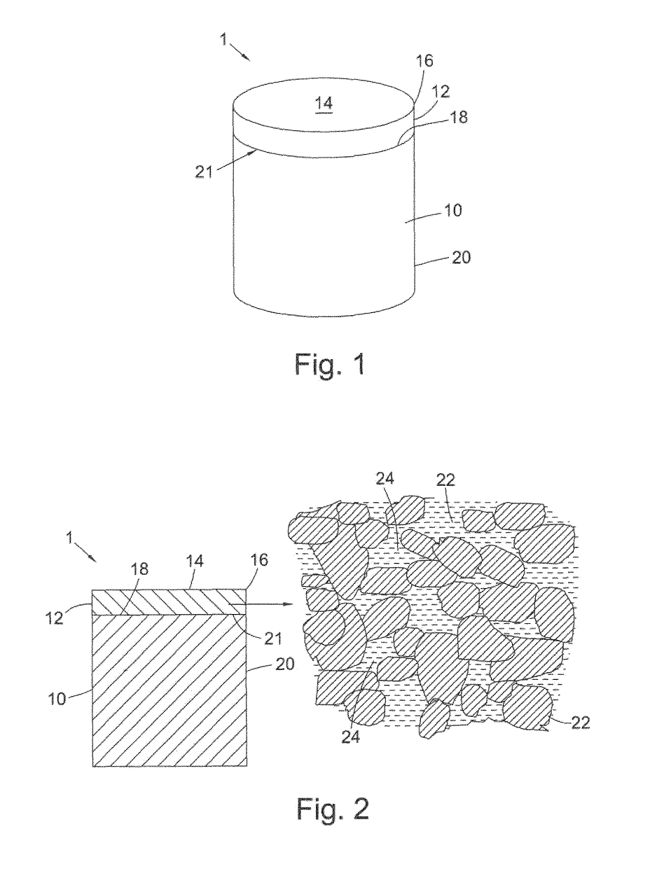

In an example as shown in FIG. 1, a cutting element 1 includes a substrate 10 with a layer of super hard material 12 formed on the substrate 10. The substrate 10 may be formed of a hard material such as cemented tungsten carbide. The super hard material 12 may be, for example, polycrystalline diamond (PCD), or a thermally stable product such as thermally stable PCD (TSP). The cutting element 1 may be mounted into a bit body such as a drag bit body (not shown) and may be suitable, for example, for use as a cutter insert for a drill bit for boring into the earth.

The exposed top surface of the super hard material opposite the substrate forms the cutting face 14, also known as the working surface, which is the surface which, along with its edge 16, performs the cutting in use.

At one end of the substrate 10 is an interface surface 18 that forms an interface with the super hard material layer 12 which is attached thereto at this interface surface. As shown in the example of FIG. 1, the substrate 10 is generally cylindrical and has a peripheral surface 20 and a peripheral top edge 21.

The super hard material may be, for example, polycrystalline diamond (PCD) and the super hard particles or grains may be of natural or synthetic origin.

The substrate 10 may be formed of a hard material such as a cemented carbide material and may be, for example, cemented tungsten carbide, cemented tantalum carbide, cemented titanium carbide, cemented molybdenum carbide or mixtures thereof. The binder metal for such carbides suitable for forming the substrate 10 may be, for example, nickel, cobalt, iron or an alloy containing one or more of these metals. Typically, this binder will be present in an amount of 10 to 20 mass %, but this may be as low as 6 mass % or less. Some of the binder metal may infiltrate the body of polycrystalline super hard material 12 during formation of the compact 1.

As shown in FIG. 2, during formation of a conventional polycrystalline composite construction, the diamond grains are directly interbonded to adjacent grains and the interstices 24 between the grains 22 of super hard material such as diamond grains in the case of PCD, may be at least partly filled with a non-super hard phase material. This non-super hard phase material, also known as a filler material may comprise residual catalyst/binder material, for example cobalt, nickel or iron and may also, or in place of, include one or more other non-super hard phase additions such as, for example, Titanium, Tungsten, Niobium, Tantalum, Zirconium, Molybdenum, Chromium, or Vanadium. In some examples, the content of one or more of these additional elements within the filler material may be, for example, about 1 weight % of the filler material in the case of Ti, about 2 weight % of the filler material in the case of V, and, in the case of W, the content of W within the filler material may be, for example, about 20 weight % of the filler material.

PCT application publication number WO2008/096314 discloses a method of coating diamond particles, to enable the formation of polycrystalline super hard abrasive elements or composites, including polycrystalline super hard abrasive elements comprising diamond in a matrix of material(s) comprising one or more of VN, VC, HfC, NbC, TaC, Mo₂C, WC. PCT application publication number WO2011/141898 also discloses PCD and methods of forming PCD containing additions such as vanadium carbide to improve, inter alia, wear resistance.

The polycrystalline composite construction 1 when used as a cutting element may be mounted in use in a bit body, such as a drag bit body (not shown).

The substrate 10 may be, for example, generally cylindrical having a peripheral surface, a peripheral top edge and a distal free end.

The working surface or “rake face” 14 of the polycrystalline composite construction 1 is the surface or surfaces over which the chips of material being cut flow when the cutter is used to cut material from a body, the rake face 14 directing the flow of newly formed chips. This face 14 is commonly also referred to as the top face or working surface of the cutting element as the working surface 14 is the surface which, along with its edge 16, is intended to perform the cutting of a body in use. It is understood that the term “cutting edge”, as used herein, refers to the actual cutting edge, defined functionally as above, at any particular stage or at more than one stage of the cutter wear progression up to failure of the cutter, including but not limited to the cutter in a substantially unworn or unused state.

As used herein, “chips” are the pieces of a body removed from the work surface of the body being cut by the polycrystalline composite construction 1 in use.

As used herein, a “wear scar” is a surface of a cutter formed in use by the removal of a volume of cutter material due to wear of the cutter. A flank face may comprise a wear scar. As a cutter wears in use, material may progressively be removed from proximate the cutting edge, thereby continually redefining the position and shape of the cutting edge, rake face and flank as the wear scar forms.

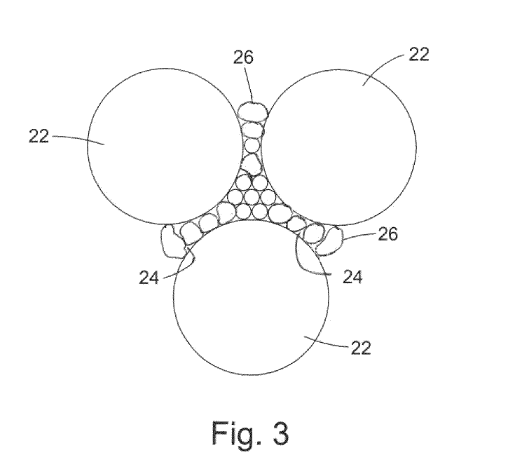

As shown in FIG. 3, during formation of a polycrystalline composite construction according to an example, the super hard material comprises a first fraction 22 of super hard grains or particles and a second fraction 26 of super hard grains or particles, the first fraction 22 having a greater average grain size than the grains of the second fraction 26. The grains of the first fraction 22 are bonded along a portion of their peripheral outer surface to plurality of grains of the second fraction and are spaced from adjacent grains in the first fraction by one or more grains in the second fraction 26.

In some examples, adjacent grains in the first fraction 22 are spaced by a distance of between around 50 to around 500 nm.

The non-super hard phase material 24 may remain in a number of the interstices between adjacent super hard grains 22, 26, but the average binder pool size of these interstices is smaller than in conventional PCD such as that shown in FIG. 2. In some examples, up to around 90% of the average binder pool size in the super hard material of FIG. 3 is between around 5 to around 50 nm.

As used herein, a PCD grade is a PCD material characterised in terms of the volume content and size of diamond grains, the volume content of interstitial regions between the diamond grains and composition of material that may be present within the interstitial regions. A grade of PCD material may be made by a process including providing an aggregate mass of diamond grains having a size distribution suitable for the grade, optionally introducing catalyst material or additive material into the aggregate mass, and subjecting the aggregated mass in the presence of a source of catalyst material for diamond to a pressure and temperature at which diamond is more thermodynamically stable than graphite and at which the catalyst material is molten. Under these conditions, molten catalyst material may infiltrate from the source into the aggregated mass and is likely to promote direct intergrowth between the diamond grains in a process of sintering, to form a PCD structure. The aggregate mass may comprise loose diamond grains or diamond grains held together by a binder material and said diamond grains may be natural or synthesised diamond grains.

Different PCD grades may have different microstructures and different mechanical properties, such as elastic (or Young's) modulus E, modulus of elasticity, transverse rupture strength (TRS), toughness (such as so-called K₁C toughness), hardness, density and coefficient of thermal expansion (CTE). Different PCD grades may also perform differently in use. For example, the wear rate and fracture resistance of different PCD grades may be different.

All of the PCD grades may comprise interstitial regions filled with material comprising cobalt metal, which is an example of catalyst material for diamond.

The PCD structure 12 of examples may comprise two or more PCD grades.

The grains of super hard material may be, for example, diamond grains or particles. In the starting mixture prior to sintering they may be, for example, bimodal, that is, the feed comprises a mixture of a coarse fraction of diamond grains and a fine fraction of diamond grains having a smaller average grain size than the coarser fraction. By “average particle or grain size” it is meant that the individual particles/grains have a range of sizes with the mean particle/grain size representing the “average”. The average particle/grain size of the fine fraction is less than the size of the coarse fraction.

In some examples, the fine grain fraction comprises between around 1 vol % to around 5 vol % super hard grains having a nano grain size, for example of between around 50 to around 500 nm.

Some examples consist of a wide bi-modal size distribution between the coarse and fine fractions of super hard material, but some examples may include three or even four or more size modes which may, for example, be separated in size by an order of magnitude.

Sizing of diamond particles/grains into fine fraction, coarse fraction, or other sizes in between, may be through known processes such as jet-milling of larger diamond grains and the like.

In some examples, the binder catalyst/solvent may comprise cobalt or some other iron group elements, such as iron or nickel, or an alloy thereof. Carbides, nitrides, borides, and oxides of the metals of Groups IV-VI in the periodic table are other examples of non-diamond material that might be added to the sinter mix. In some examples, the binder/catalyst/sintering aid may be Co.

The cemented metal carbide substrate may be conventional in composition and, thus, may be include any of the Group IVB, VB, or VIB metals, which are pressed and sintered in the presence of a binder of cobalt, nickel or iron, or alloys thereof. In some examples, the metal carbide is tungsten carbide.

The cutter of FIG. 1 having the microstructure of FIG. 3 may be fabricated, for example, as follows.

As used herein, a “green body” is a body comprising grains to be sintered and a means of holding the grains together, such as a binder, for example an organic binder.

The green body may also comprise catalyst material for promoting the sintering of the super hard grains. The green body may be made by combining the grains or particles of super hard material with the binder/catalyst and forming them into a body having substantially the same general shape as that of the intended sintered body, and drying the binder. At least some of the binder material may be removed by, for example, burning it off.

A green body for the super hard construction may be placed onto a substrate, such as a pre-formed cemented carbide substrate to form a pre-sinter assembly, which may be encapsulated in a capsule for an ultra-high pressure furnace, as is known in the art. The substrate may provide a source of catalyst material for promoting the sintering of the super hard grains. In some examples, the super hard grains may be diamond grains and the substrate may be cobalt-cemented tungsten carbide, the cobalt in the substrate being a source of catalyst for sintering the diamond grains. The pre-sinter assembly may comprise an additional source of catalyst material.

In one version, the method may include loading the capsule comprising a pre-sinter assembly into a press and subjecting the green body to an ultra-high pressure and a temperature at which the super hard material is thermodynamically stable to sinter the super hard grains. In some examples, the green body may comprise diamond grains and the pressure to which the assembly is subjected is at least about 5 GPa and the temperature is at least about 1,300 degrees centigrade.

A powder blend comprising diamond particles, and a metal binder material, such as cobalt may be prepared by combining these particles and blending them together. An effective powder preparation technology may be used to blend the powders, such as wet or dry multi-directional mixing, planetary ball milling and high shear mixing with a homogenizer. In one example, the diamond particles may be combined with other particles by mixing the powders or, in some cases, stirring the powders together by hand. In one version of the method, precursor materials suitable for subsequent conversion into binder material may be included in the powder blend, and in one version of the method, metal binder material may be introduced in a form suitable for infiltration into a green body. The powder blend may be deposited in a die or mold and compacted to form a green body, for example by uni-axial compaction or other compaction method, such as cold isostatic pressing (CIP). The green body may be subjected to a sintering process known in the art to form a sintered article. In one version, the method may include loading the capsule comprising a pre-sinter assembly into a press and subjecting the green body to an ultra-high pressure and a temperature at which the super hard material is thermodynamically stable to sinter the super hard grains.

After sintering, the polycrystalline super hard constructions may be ground to size and may include, if desired, a 45° chamfer of approximately 0.4 mm height on the body of polycrystalline super hard material so produced.

The sintered article may be subjected to a subsequent treatment at a pressure and temperature at which diamond is thermally stable to convert some or all of the non-diamond carbon back into diamond and produce a diamond composite structure. An ultra-high pressure furnace well known in the art of diamond synthesis may be used and the pressure may be at least about 5.5 GPa and the temperature may be at least about 1,250 degrees centigrade for the second sintering process.

A further example of a super hard construction may be made by a method including providing a PCD structure and a precursor structure for a diamond composite structure, forming each structure into the respective complementary shapes, assembling the PCD structure and the diamond composite structure onto a cemented carbide substrate to form an unjoined assembly, and subjecting the unjoined assembly to a pressure of at least about 5.5 GPa and a temperature of at least about 1,250 degrees centigrade to form a PCD construction. The precursor structure may comprise carbide particles and diamond or non-diamond carbon material, such as graphite, and a binder material comprising a metal, such as cobalt. The precursor structure may be a green body formed by compacting a powder blend comprising particles of diamond or non-diamond carbon and particles of carbide material and compacting the powder blend.

In some examples, both the bodies of, for example, diamond and carbide material plus the sintering aid/binder/catalyst are applied as powders and sintered simultaneously in a single UHP/HT process. The mixture of diamond grains, and mass of carbide are placed in an HP/HT reaction cell assembly and subjected to HP/HT processing. The HP/HT processing conditions selected are sufficient to effect intercrystalline bonding between adjacent grains of abrasive particles and, optionally, the joining of sintered particles to the cemented metal carbide support. In one example, the processing conditions generally involve the imposition for about 3 to 120 minutes of a temperature of at least about 1200 degrees C. and an ultra-high pressure of greater than about 5 GPa.

In another example, the substrate may be pre-sintered in a separate process before being bonded together in the HP/HT press during sintering of the ultrahard polycrystalline material.

In a further example, both the substrate and a body of polycrystalline super hard material are pre-formed. For example, the bimodal feed of ultrahard grains/particles and optional carbonate binder-catalyst also in powdered form are mixed together, and the mixture is packed into an appropriately shaped canister and is then subjected to extremely high pressure and temperature in a press. Typically, the pressure is at least 5 GPa and the temperature is at least around 1200 degrees C. The preformed body of polycrystalline super hard material is then placed in the appropriate position on the upper surface of the preform carbide substrate (incorporating a binder catalyst), and the assembly is located in a suitably shaped canister. The assembly is then subjected to high temperature and pressure in a press, the order of temperature and pressure being again, at least around 1200 degrees C. and 5 GPa respectively. During this process the solvent/catalyst migrates from the substrate into the body of super hard material and acts as a binder-catalyst to effect intergrowth in the layer and also serves to bond the layer of polycrystalline super hard material to the substrate. The sintering process also serves to bond the body of super hard polycrystalline material to the substrate.

In examples where the cemented carbide substrate does not contain sufficient solvent/catalyst for diamond, and where the PCD structure is integrally formed onto the substrate during sintering at an ultra-high pressure, solvent/catalyst material may be included or introduced into the aggregated mass of diamond grains from a source of the material other than the cemented carbide substrate. The solvent/catalyst material may comprise cobalt that infiltrates from the substrate in to the aggregated mass of diamond grains just prior to and during the sintering step at an ultra-high pressure. However, in examples where the content of cobalt or other solvent/catalyst material in the substrate is low, particularly when it is less than about 11 weight percent of the cemented carbide material, then an alternative source may need to be provided in order to ensure good sintering of the aggregated mass to form PCD.

Solvent/catalyst for diamond may be introduced into the aggregated mass of diamond grains by various methods, including blending solvent/catalyst material in powder form with the diamond grains, depositing solvent/catalyst material onto surfaces of the diamond grains, or infiltrating solvent/catalyst material into the aggregated mass from a source of the material other than the substrate, either prior to the sintering step or as part of the sintering step. Methods of depositing solvent/catalyst for diamond, such as cobalt, onto surfaces of diamond grains are well known in the art, and include chemical vapour deposition (CVD), physical vapour deposition (PVD), sputter coating, electrochemical methods, electroless coating methods and atomic layer deposition (ALD). It will be appreciated that the advantages and disadvantages of each depend on the nature of the sintering aid material and coating structure to be deposited, and on characteristics of the grain.

In one example, the binder/catalyst such as cobalt may be deposited onto surfaces of the diamond grains by first depositing a pre-cursor material and then converting the precursor material to a material that comprises elemental metallic cobalt. For example, in the first step cobalt carbonate may be deposited on the diamond grain surfaces using the following reaction:

Co(NO3)2+Na2CO3->CoCO3+2NaNO3

The deposition of the carbonate or other precursor for cobalt or other solvent/catalyst for diamond may be achieved by means of a method described in PCT patent publication number WO2006/032982. The cobalt carbonate may then be converted into cobalt and water, for example, by means of pyrolysis reactions such as the following:

CoCO3->CoO+CO2

CoO+H2->Co+H2O

In another example, cobalt powder or precursor to cobalt, such as cobalt carbonate, may be blended with the diamond grains. Where a precursor to a solvent/catalyst such as cobalt is used, it may be necessary to heat treat the material in order to effect a reaction to produce the solvent/catalyst material in elemental form before sintering the aggregated mass.

In some examples, the cemented carbide substrate may be formed of tungsten carbide particles bonded together by the binder material, the binder material comprising an alloy of Co, Ni and Cr. The tungsten carbide particles may form at least 70 weight percent and at most 95 weight percent of the substrate. The binder material may comprise between about 10 to 50 wt. % Ni, between about 0.1 to 10 wt. % Cr, and the remainder weight percent comprises Co.

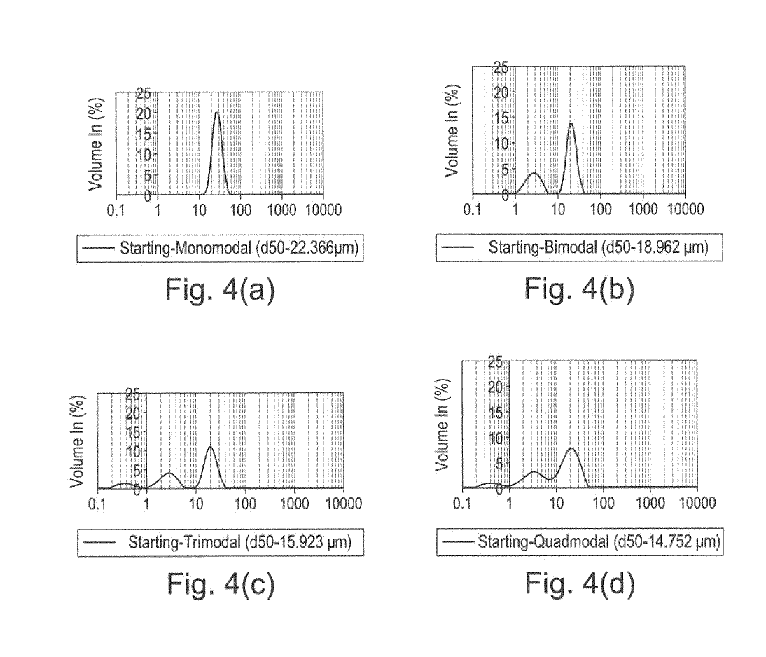

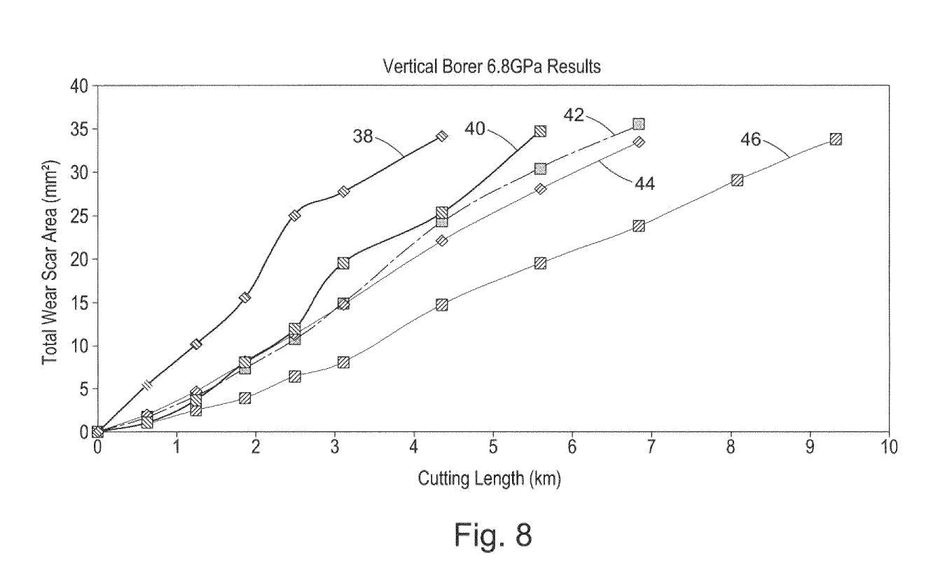

Various samples of PCD material were prepared and analysed by subjecting the samples to a number of tests. The results of these tests are shown in FIGS. 4a and 8.

### Examples

Some examples are discussed in more detail below with reference to the following examples, which are not intended to be limiting.

Two conventional PCD cutters and two example cutters were formed by the following method.

Four initial powder compositions were prepared. The first (grade A) comprised 100 wt. % of diamond particles having an average grain size of 30 microns. A second grade (grade B) comprised 70 wt % of diamond particles having an average grain size of 30 microns and 30 wt % of diamond particles having an average grain size of 4 microns. A third grade (grade C) comprised 70 wt % of diamond particles having an average grain size of 30 microns, 30 wt % of diamond particles having an average grain size of 4 microns and 13 wt % of diamond particles having an average grain size of 0.5 microns. A fourth grade (grade D) comprised 70 wt % of diamond particles having an average grain size of 30 microns, 30 wt % of diamond particles having an average grain size of 4 microns and 13 wt % of diamond particles having an average grain size of 0.5 microns and 2 wt % of nanodiamond particles having an average grain size of between 50 to 500 microns.

In order to understand the various powders as they undergo densification, the initial particle size distribution of the starting powder was measured using a Malvern Particle size analyser. The results are shown in FIGS. 4a to 4d for grades A to D respectively. It will be seen that particles in the first grade (grade A) comprise a monomodal distribution), the second grade (grade B) is a bimodal distribution, the third grade (grade C) is a trimodal mixture and the fourth grade (grade D) is a quadmodal mixture.

A cold compaction study was conducted in a piston cylinder type press. Critical parameters varied in this stage of compaction were applied pressure (GPa) and starting average grain size distribution. In general, for all four powder variants studied, it was determined that crushing increases with an increase in applied pressure. As a result, more fine grained particles were generated at an elevated pressure. Grade A (formed of 100 wt % particles having an average grain size of 30 microns) showed significant crushing under applied load as compared to the other three powder mixtures. The distribution for this powder mixture was skewed towards the finer sizes. The results showed that crushing efficiency decreases as fine grades are introduced starting powder. According to the observations, it appears that the extent of crushing is substantial for Grade A powder, but this is not the case for the other powders, with regard to the average particles size. The presence of finer grained particles in the mixture as in the case of the bimodal, trimodal and quadmodal mixtures tend to protect the coarse particles from the effects of applied load.

After the green bodies formed of the above diamond mixtures were assembled in the capsules for sintering, a hot compaction stage was performed. In order to effect this stage, heat was applied at the higher pressures which were under investigation, namely 5.5, 6.8 and 7.7 GPa. When heat was applied at elevated pressures, it was determined that diamond compact densification occurred primarily by crushing and rearrangements of the crushed particles. It was further determined that this proceeds up to the temperature of approximately 700° C., after which densification proceeded by plastic deformation. The degree to which plastic deformation occurred at higher temperatures was observed to be dependent on the applied load. This was seen when polished hot compacted PCD discs of various loading conditions were analysed under an SEM

For all four powders investigated, a change in morphology was observed at elevated temperature as load was increased from 5.5 to 7.7 GPa. Initially blocky and irregular shaped diamond grains became more rounded, their sharp edges disappeared and deformation appears to have initiated in the zones of contact with each other, forming a skeleton structure. It is believed that the points of contact between individual diamond grains act as stress raisers, leading to intense deformation taking place. Much of this effect is more evident in monomodal and bimodal powder mixes which have achieved substantial crushing and particle rearrangement in the preceding stage to compaction. Very little of this effect occurs for trimodal and quadmodal mixtures which contain finer grains in the starting powder. As pressure was increased, pores inbetween the diamond grains decreased. SEM images show that pores decreased faster for the monomodal mixture containing coarser starting grains which achieved intensive crushing at the end of cold compaction stage.

In order to understand the powders as they undergo densification, it was necessary to study the initial powder packing resulting from the multi-modal mixes. This was achieved through analysis performed in a Malvern particle size analyser in which the particle size distribution of the starting powder was studied, as shown in FIG. 4a or 4d. The initial starting powders were also analysed using an SEM technique. Grades A, B and D all showed well mixed aggregated masses and mixing of particles with no evidence of inhomogeneity or agglomeration problems being observed when both analysis techniques were used.

During the sintering process of the super hard material (e.g. PCD), interaction between diamond and cobalt occurs. The combined effects of temperature and oxidising atmosphere induces graphitization of the diamond surfaces. Graphite forms under these conditions dissolved into cobalt, giving rise to a solid solution. As a result, a strong chemical interaction in a diamond-Cobalt system takes place, thereby favouring strong chemical bonding.

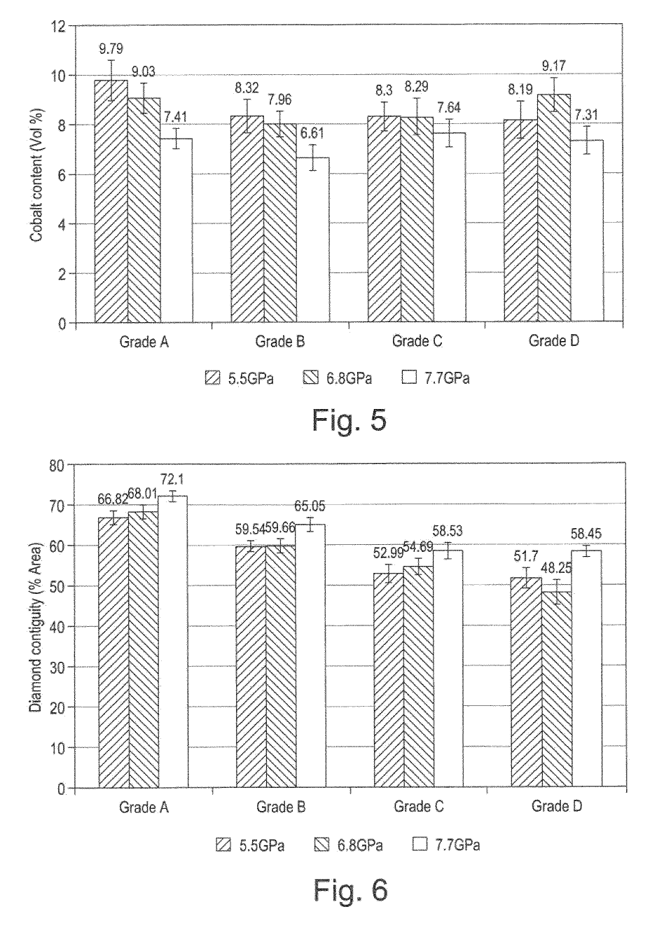

Cobalt (binder phase) content in the microstructure decreases with an increase in applied pressure i.e. material becomes denser as applied load is increased for all powder variants. As shown in FIG. 5, as fine particles (e.g. into Grades C and D) are introduced in the starting powder, the resulting microstructures show that cobalt content is the lowest in the microstructure containing fine starting powder. Further, increasing the vol % of finer grains in the starting powder yields more benefits to reduce the presence of cobalt in the microstructure, as shown results achieved using an ICP technique. In such a technique, the sintered body of superhard material is weighed and ashed to burn off carbon. The ashed powder is weighed again and dissolved in acid which mainly dissolves the cobalt. Undissolved carbon is filtered and the acid binder solution is diluted to a set volume. The solution is then measured for concentration of the binder using an ICP technique. From such ICP results, determination of the binder content and percentage is possible. In connectoin with the bodies of super hard material formed from grades A to D as described above, these results indicated that increasing the number of size components has a potential for producing denser packing of the super hard grains in the sintered product. The depth of penetration and the amount of cobalt in the diamond layer during sintering was found to depend on the starting grain size of the super hard grains as well as sintering pressure. Sintering of finer grained starting powder was found to be relatively difficult compared to a coarser starting grain size.

As used herein, “diamond grain contiguity” κ is calculated according to the following formula using data obtained from image analysis of a polished section of PCD material:

κ(=100*[2*(δ−β)]/[(2*(δ−β))+δ], where δ is the diamond perimeter, and β is the binder perimeter.

As used herein, the diamond perimeter is the fraction of diamond grain surface that is in contact with other diamond grains. It is measured for a given volume as the total diamond-to-diamond contact area divided by the total diamond grain surface area. The binder perimeter is the fraction of diamond grain surface that is not in contact with other diamond grains. In practice, measurement of contiguity is carried out by means of image analysis of a polished section surface. The combined lengths of lines passing through all points lying on all diamond-to-diamond interfaces within the analysed section are summed to determine the diamond perimeter, and analogously for the binder perimeter.

Images used for the image analysis should be obtained by means of scanning electron micrographs (SEM) taken using a backscattered electron signal. Optical micrographs may not have sufficient depth of focus and may give substantially different contrast. The method of measuring diamond grain contiguity requires that distinct diamond grains in contact with or bonded to each other can be distinguished from single diamond grains. Adequate contrast between the diamond grains and the boundary regions between them may be important for the measurement of contiguity since boundaries between grains may be identified on the basis of grey scale contrast. Boundary regions between diamond grains may contain included material, such as catalyst material, which may assist in identifying the boundaries between grains.

It is known that, conventionally, with regard to PCD material, diamond contiguity increases with an increase in sintering pressure i.e. as intensity of applied pressure increases, more solid-solid contact occurs between diamond grains. Diamond contiguity was found to be the highest for monomodal mix and decreased sharply as the population of successively finer particles were introduced in the starting powder. Nanodiamond particles in the starting powder negated this trend at 5.5 and 7.7 GPa in which sharp drop in contiguity reaches equilibrium after trimodal mix. This is shown in FIG. 6.

As sintering pressure was increased from 5.5 to 7.7 GPa, it was found that fragmentation intensity increased and the resulting average particle size in the microstructure reduced. The bimodal mixture showed less particle fragmentation believed to be due to a cushioning effect of fine grained super hard material added, resulting in the highest average particle size. Maximum compaction was found to be highest in the compacts containing the larger starting particle size. The extent of compaction is such that the final average particle size of the coarser starting powder compacts is similar to the compacts with finer starting powder. A slight increase in average size of the particles containing fine grains in the starting powder was due to a grain growth in which larger grains grow at an expense of the finer grain size. Whilst not wishing to be bound by a particular theory, it is proposed that when diamond powder mixture of fine and coarser starting grains size is sintered in the presence of Co solvent at high temperature and pressure, the fine grains first adhere to the coarser grains and finally coalesce with them. This was also evident when comparing the grains in the microstructures of the compact containing coarser and finer starting grain sizes (grades C and D).

As used herein, the “interstitial mean free path” within a polycrystalline material comprising an internal structure including interstices or interstitial regions, such as PCD, is understood to mean the average distance across each interstitial between different points at the interstitial periphery. The average mean free path is determined by averaging the lengths of many lines drawn on a micrograph of a polished sample cross section. The mean free path standard deviation is the standard deviation of these values. The diamond mean free path is defined and measured analogously.

The homogeneity or uniformity of a PCD structure may be quantified by conducting a statistical evaluation using a large number of micrographs of polished sections. The distribution of the filler phase, which is easily distinguishable from that of the diamond phase using electron microscopy, can then be measured in a method similar to that disclosed in EP 0 974 566 (see also WO2007/110770). This method allows a statistical evaluation of the average thicknesses of the binder phase along several arbitrarily drawn lines through the microstructure. This binder thickness measurement is also referred to as the “mean free path” by those skilled in the art. For two materials of similar overall composition or binder content and average diamond grain size, the material that has the smaller average thickness will tend to be more homogenous, as this implies a finer scale distribution of the binder in the diamond phase. In addition, the smaller the standard deviation of this measurement, the more homogenous is the structure. A large standard deviation implies that the binder thickness varies widely over the microstructure, i.e. that the structure is not even, but contains widely dissimilar structure types.

Images used for the image analysis should be obtained by means of scanning electron micrographs (SEM) taken using a backscattered electron signal. Optical micrographs may not have sufficient depth of focus and may give substantially different contrast. The method of measuring diamond grain contiguity requires that distinct diamond grains in contact with or bonded to each other can be distinguished from single diamond grains. Adequate contrast between the diamond grains and the boundary regions between them may be important for the measurement of contiguity since boundaries between grains may be identified on the basis of grey scale contrast. Boundary regions between diamond grains may contain included material, such as catalyst material, which may assist in identifying the boundaries between grains.

The sintered constructions formed according to the above examples were also analysed to determine the respective cobalt pool sizes in the material, as measured on a surface of, or a section through a body comprising PCD material. No stereographic correction was applied. Unless otherwise stated herein, dimensions of size, distance, and perimeter and so forth relating to grains and interstices within PCD material, as well as the grain contiguity, refer to the dimensions as measured on a surface of, or a section through a body comprising PCD material and no stereographic correction has been applied. For example, the size distributions of the diamond grains of examples of the invention were measured by means of image analysis carried out on a polished surface, and a Saltykov correction was not applied.

In measuring the mean value and deviation of a quantity such as grain contiguity, or other statistical parameter measured by means of image analysis, several images of different parts of a surface or section are used to enhance the reliability and accuracy of the statistics. The number of images used to measure a given quantity or parameter may be at least about 9 or even up to about 36. The number of images used may be, for example, about 16. The resolution of the images needs to be sufficiently high for the inter-grain and inter-phase boundaries to be clearly made out. In the statistical analysis, typically 16 images are taken of different areas on a surface of a body comprising the PCD material, and statistical analyses are carried out on each image as well as across the images. Each image should contain at least about 30 diamond grains, although more grains may permit more reliable and accurate statistical image analysis.

Such an image analysis technique was used to determine the cobalt pool sizes in the various PCD constructions formed as described in the examples above. It was determined that, for grades C and D, namely where the starting material comprised between around 1 to 5 vol % diamond grains having an average grain size of between around 50 to around 500 nm, that up to around 90% of the cobalt pools had an average size of between around 5 to 50 nm.

Furthermore, it was also determined that cobalt pool size decreased exponentially with an increase in sintering pressure. A higher cobalt pool size was observed in the compacts formed from a large starting grain size (grades A and B), and decreased sharply as fines were introduced in the initial powder (grades C and D). The higher cobalt pool size in the constructions having a coarser starting grain size was attributed to large voids forming between the grains of diamond layer during sintering. It is believed that pressure in the voids or interstitial spaces is lower than that in the grains, hence, cobalt is sucked into larger voids between the grains in the diamond layer. Finer particles generated during the compaction stage and also added in the starting powder were found to have an incremental benefit to cobalt pool size reduction. Microstructures resulting from the quadmodal mix (grade D) showed a heterogeneous distribution of cobalt. This may be attributed to the observations that very fine powdered diamonds added in the initial powder formed agglomerates of a certain size in microns, which are usually densely compacted. When Co infiltrates into the diamond layer, it is difficult to infiltrate through these agglomerates forming a non-uniform distribution of Co. On the other hand, for constructions produced from the relatively coarser grain sizes of 4 to 30 μm, cobalt infiltrated uniformly throughout the diamond layer. In some cases a thin Co layer was formed.

SEM observation showed that, with the coarse grain compacts (grades C and D), there was little direct diamond-diamond bonding in the microstructure between the larger grain sized fraction, with a portion of the peripheral surfaces of the larger grains being directly bonded to the nano grains which separated adjacent larger grains by a distance of between around 50 to around 500 nm.

As used herein, the words “average” and “mean” have the same meaning and are interchangeable.

Diamond contiguity is an important performance indicator, as it indicates the degree of intergrowth or bonding between the diamond particles, and all else being equal the higher the diamond contiguity the better the cutter performance. Higher diamond contiguity is normally associated with high diamond content which in turn results in lower binder content, as the high diamond content translates into low porosity and therefore low binder content, as the binder occupies the pores.

According to classic materials science of composite materials, low binder content results in low fracture toughness, as it is normally the hard grains (in this case diamond) that imparts hardness to the composite material, and the more ductile binder (in PCD, normally Co—WC) that imparts toughness to the composite material.

Therefore, high diamond content and low binder content are expected to be associated with increased hardness and decreased toughness, so that failure due to fracture or spalling of the PCD is expected to increase.

It was therefore surprising to find that PCD with improved wear performance may be obtained by adding nanodiamond particles to the green body prior to sintering at HPHT, as is evidenced by the results of an analysis of the wear performance of the PCD material formed from grades C and D.

Using a nanodiamond additive in this way results in an unusual combination of diamond content, binder content and diamond contiguity, which, whilst resulting in a decrease in diamond contiguity combined with a decrease in the binder pool sizes. This unusual combination may result in improved wear performance without compromising toughness.

A number of PCD compacts formed according to the above examples (comprising grades C and D described above) were compared in a vertical boring mill test with the commercially available polycrystalline diamond cutter elements (comprising grades A and B described above).

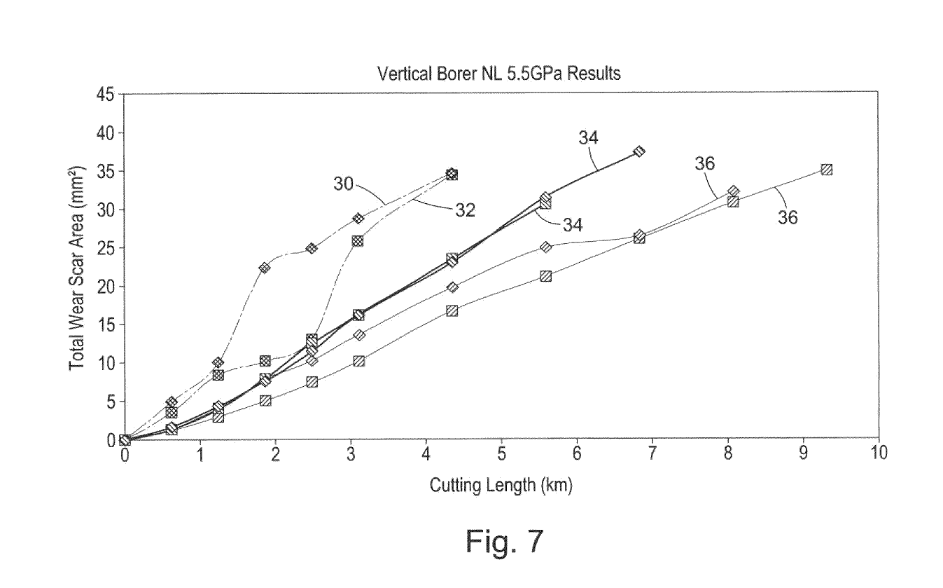

The results are shown in FIGS. 7 and 8 where the plots in FIG. 7 relate to constructions sintered at a pressure of 5.5 GPa and those in FIG. 8 relate to constructions sintered at a pressure of 6.8 GPa.

The first PCD construction tested was that formed of the conventional unimodal diamond grain mixture (grade A described above) and the results are shown in FIG. 7 by lines 30 and 32. The second PCD construction tested was a first example formed of the trimodal mixture (grade C described above) and the results are shown in FIG. 7 by lines 34. The third PCD construction tested was a second example formed of the quadmodal mixture (grade D described above) and the results are shown in FIG. 7 by lines 36. In this test, the wear flat area was measured as a function of the number of passes of the construction boring into the workpiece and the results obtained are illustrated graphically in FIG. 7.

The results provide an indication of the total wear scar area plotted against cutting length. It will be seen that the PCD compacts formed according to examples (lines 34 and 36) were able to achieve a significantly greater cutting length than that occurring in the conventional PCD compact (shown by lines 30 and 32 in FIG. 7) which was subjected to the same test for comparison.

Similarly, the test was repeated on constructions sintered at the higher pressure of 6.8 GPa and the results are shown in FIG. 8. The first PCD construction tested was that formed of the conventional unimodal diamond grain mixture (grade A described above) and the results are shown in FIG. 8 by lines 38 and 40. The second PCD construction tested was a second conventional PCD bimodal mixture (grade B described above) and the results are shown in FIG. 8 by line 42. The third PCD construction tested was a first example formed of the quadmodal mixture (grade D described above) and the results are shown in FIG. 8 by lines 44 and 46.

Again it will be seen that PCD compacts formed according to an examples (lines 44 and 46 in FIG. 8) were able to achieve a significantly greater cutting length than that occurring in the conventional PCD compact (shown by lines 38, 40 and 42 in FIG. 8) which were subjected to the same test for comparison.

Thus, examples of a PCD material may be formed having that a combination of high abrasion and fracture performance which is surprising considering the reduction in diamond contiguity in those PCD constructions.

The PCD construction 1 described with reference to FIGS. 1 and 3, may be further processed after sintering. For example, catalyst material may be removed from a region of the PCD structure adjacent the working surface or the side surface or both the working surface and the side surface. This may be done by treating the PCD structure with acid to leach out catalyst material from between the diamond grains, or by other methods such as electrochemical methods. A thermally stable region, which may be substantially porous, extending a depth of at least about 50 microns or at least about 100 microns from a surface of the PCD structure, may thus be provided which may further enhance the thermal stability of the PCD element.

Furthermore, the PCD body in the structure of FIG. 1 comprising a PCD structure bonded to a cemented carbide support body may be created or finished by, for example, grinding, to provide a PCD element which is substantially cylindrical and having a substantially planar working surface, or a generally domed, pointed, rounded conical or frusto-conical working surface. The PCD element may be suitable for use in, for example, a rotary shear (or drag) bit for boring into the earth, for a percussion drill bit or for a pick for mining or asphalt degradation.

While various examples have been described with reference to a number of examples, those skilled in the art will understand that various changes may be made and equivalents may be substituted for elements thereof and that these examples are not intended to limit the particular examples disclosed.

For example, in some examples of the method, the PCD material may be sintered for a period in the range from about 1 minute to about 30 minutes, in the range from about 2 minutes to about 15 minutes, or in the range from about 2 minutes to about 10 minutes.

In some examples of the method, the sintering temperature may be in the range from about 1,400 degrees centigrade to about 2,300 degrees centigrade, in the range from about 1,400 degrees centigrade to about 2,000 degrees centigrade, in the range from about 1,450 degrees centigrade to about 1,700 degrees centigrade, or in the range from about 1,450 degrees centigrade to about 1,650 degrees centigrade.

In some examples, the method may include subjecting the PCD material to a heat treatment at a temperature of at least about 500 degrees centigrade, at least about 600 degrees centigrade or at least about 650 degrees centigrade for at least about 30 minutes. In some examples, the temperature may be at most about 850 degrees centigrade, at most about 800 degrees centigrade or at most about 750 degrees centigrade. In some examples, the PCD body may be subjected to the heat treatment for at most about 120 minutes or at most about 60 minutes. In one example, the PCD body may be subjected to the heat treatment in a vacuum.

Some examples of the method may include subjecting the PCD material to a further pressure treatment at a pressure of at least about 2 GPa, at least about 5 GPa or even at least about 6 GPa. In some examples, the further pressure treatment may be applied for a period of at least about 10 seconds or at least about 30 seconds. In one example, the further pressure treatment may be applied for a period of at most about 20 minutes.

In one example, the method may include removing metallic catalyst material for diamond from interstices between the diamond grains of the PCD material.

An example provides a PCD structure for cutting, boring into or degrading a body, at least a part of the PCD structure comprising a volume of an example of PCD material according to an aspect of the invention. In some examples, at least part of the volume of the PCD material may have a thickness in the range from about 3.5 mm to about 12.5 mm or in the range from about 4 mm to about 7 mm.

In some examples, the PCD structure may have a region adjacent a surface comprising at most about 2 volume percent of catalyst material for diamond, and a region remote from the surface comprising greater than about 2 volume percent of catalyst material for diamond. In some examples, the region adjacent the surface may extend to a depth of at least about 20 microns, at least about 80 microns, at least about 100 microns or even at least about 400 microns from the surface.

1. A super hard polycrystalline construction comprising:
a body of polycrystalline super hard material comprising a first fraction of super hard grains and a second fraction of super hard grains, the first fraction having a greater average grain size than the super hard grains in the second fraction;
the super hard grains in the first and second fraction having a peripheral surface; wherein
the super hard grains in the first fraction are bonded along at least a portion of the peripheral surface to at least a portion of a plurality of super hard grains in the second fraction;
the super hard grains in the first fraction being spaced from adjacent grains in the first fraction by a distance of between around 50 to around 500 nm.

2. The super hard polycrystalline construction of claim 1, further comprising a substrate attached to the body of polycrystalline super hard material along an interface.

3. The super hard polycrystalline construction of claim 1, wherein the body of super hard material comprises inter-bonded super hard grains comprising natural and/or synthetic diamond grains, the super hard polycrystalline construction forming a polycrystalline diamond (PCD) construction.

4. The super hard polycrystalline construction of claim 3, wherein the PCD construction further comprises a non-super hard phase comprising a binder phase located in interstitial spaces between the inter-bonded diamond grains.

5. The super hard polycrystalline construction according to claim 4, wherein the binder phase comprises cobalt, and/or one or more other iron group elements, such as iron or nickel, or an alloy thereof, and/or one or more carbides, nitrides, borides, and oxides of the metals of Groups IV-VI in the periodic table.

6. The super hard polycrystalline construction according to claim 1, wherein the substrate comprises a cemented carbide substrate bonded to the body of polycrystalline material along the interface.

7. The super hard polycrystalline construction according to claim 6, wherein the cemented carbide substrate comprises tungsten carbide particles bonded together by a binder material, the binder material comprising an alloy of Co, Ni and Cr.

8. The super hard polycrystalline construction according to claim 6, wherein the cemented carbide substrate comprises between around 8 to 13 weight or volume % binder material.

9. The super hard polycrystalline construction according to claim 6, wherein at least a portion of the body of super hard material is substantially free of a catalyst material for diamond, said portion forming a thermally stable region.

10. The super hard polycrystalline construction as claimed in claim 9, wherein the thermally stable region comprises at most 2 weight percent of catalyst material for diamond.

11. The super hard polycrystalline construction of claim 1, wherein the second fraction comprises between around 1 vol % to around 5 vol % nano particles having an average grain size of between around 50 to around 500 nm.

12. The super hard polycrystalline construction of claim 1, wherein the second fraction comprises between around 1 vol % to around 4 vol % nano particles having an average grain size of between around 50 to around 500 nm.

13. The super hard polycrystalline construction of claim 1, wherein the second fraction comprises between around 2 vol % to around 3 vol % nano particles having an average grain size of between around 50 to around 500 nm.

14. The super hard polycrystalline construction of claim 1, wherein the first fraction comprises a mass of super hard abrasive grains having two or more different average grain sizes.

15. The super hard polycrystalline construction of claim 1, wherein interstitial spaces between the inter-bonded grains of the first and second fractions of super hard material have a cross-sectional size of between around 5 nm to around 50 nm.

16. A super hard polycrystalline construction for a rotary shear bit for boring into the earth, or for a percussion drill bit, comprising a super hard polycrystalline construction as claimed in claim 1 bonded to a cemented carbide support body.

17. A method of forming a super hard polycrystalline construction, comprising:
providing a first mass of particles or grains of super hard material forming a first fraction and a mass of particles or grains of super hard material forming a second fraction to form a pre-sinter assembly; the first fraction having a greater average grain size than the super hard grains in the second fraction; the first fraction comprising two or more average particle sizes; the second fraction comprising grains having an average particle size of between around 50 to around 500 nm;
treating the pre-sinter assembly in the presence of a catalyst/solvent material for the super hard grains at an ultra-high pressure of around 5 GPa or greater and a temperature to sinter together the grains of super hard material to form a body of polycrystalline super hard material, the super hard grains exhibiting inter-granular bonding and defining a plurality of interstitial regions therebetween;
the super hard grains in the first and second fraction having a peripheral surface; wherein
the super hard grains in the first fraction are bonded along at least a portion of the peripheral surface to at least a portion of a plurality of super hard grains in the second fraction;
the super hard grains in the first fraction being spaced from adjacent grains in the first fraction by a distance of between around 50 to around 500 nm.

18. The method of claim 17, wherein the step of providing a first and second mass comprises providing a first mass and/or second mass of natural and/or synthetic diamond grains, the super hard polycrystalline construction forming a polycrystalline diamond (PCD) construction.

19. The method of claim 18, wherein the temperature in the step of treating is a temperature at which the super hard material is more thermodynamically stable than graphite.

20. The method of claim 17, further comprising treating the super hard construction to remove at least a portion of residual binder/catalyst from at least a portion of interstitial spaces between interbonded super hard grains.

21. The method of claim 17, wherein the step of providing a second fraction comprises providing a mass of grains comprising between around 1 vol % to around 5 vol % nano particles having an average grain size of between around 50 to around 500 nm.

22.-28. (canceled)
